(19) United States
(12) Patent Application Publication
(10) Pub. No.: US 2014/0321663 A1
(43) Pub. Date: Oct. 30, 2014

(54) METHOD AND APPARATUS FOR TRANSMITTING MULTI-CHANNEL AUDIO SIGNAL

(71) Applicant: CORE LOGIC INC., Seoul (KR)

(72) Inventor: MI-OCK CHI, Seoul (KR)

(73) Assignee: CORE LOGIC INC., Seoul (KR)

(21) Appl. No.: 14/259,393

(22) Filed: Apr. 23, 2014

(30) Foreign Application Priority Data
Apr. 26, 2013 (KR) 10-2013-0046897

(51) Int. Cl. H04R 3/12

(52) U.S. Cl. CPC H04R 3/12
USPC 381/80

(57) ABSTRACT

Disclosed herein is a method and apparatus for transmitting a multi-channel audio signal. The method includes determining whether an audio signal is a multi-channel audio signal; changing a format of a subframe if the received audio signal is a multi-channel audio signal as a result of the confirmation; inserting a channel identifier into an ancillary data region of the subframe of which the format is changed; and creating an audio bit stream including the ancillary data region into which the channel identifier is inserted.

### CROSS-REFERENCE TO RELATED APPLICATION

This application claims priority to Korean Patent Application No. 10-2013-0046897 filed on 26 Apr., 2013, and all the benefits accruing therefrom under 35 U.S.C. §119, the contents of which is incorporated by reference in its entirety.

### BACKGROUND

1. Technical Field

The present invention relates to a method and apparatus for transmitting a multi-channel audio signal.

2. Description of the Related Art

The present invention relates to a method and apparatus for transmitting an audio signal. General techniques for compressing and restoring a signal have been introduced and these techniques are being developed in a direction of improving quality of sound while enhancing a compression rate. In addition, various attempts have been made to enhance transmission efficiency to be adapted to a variety of communication environments.

### BRIEF SUMMARY

It is an aspect of the present invention to provide a method and apparatus for transmitting a multi-channel audio signal, which optimizes efficiency of transmitting a multi-channel audio signal.

In accordance with one aspect, the present invention provides a method of transmitting a multi-channel audio signal, which includes: changing a format of a subframe if an audio signal is a multi-channel audio signal; inserting a channel identifier into an ancillary data region of the subframe, the format of which is changed; and creating an audio bit stream including the ancillary data region into which the channel identifier is inserted.

The present invention provides the method of transmitting a multi-channel audio signal, which removes the audio data region of the subframe and inserts an ancillary data region into the removed audio data region.

The present invention provides the method of transmitting a multi-channel audio signal, in which a size of the inserted ancillary data region is variably determined according to the number of channels of the multi-channel audio signal, and the removed audio data region has the same size as that of the inserted ancillary data region.

The present invention provides the method of transmitting a multi-channel audio signal, in which the removed audio data region is placed at a least significant bit.

In accordance with another aspect, the present invention provides a method of transmitting a multi-channel audio signal, which includes: determining whether ancillary data is included in an ancillary data region of a subframe if a received audio signal is a multi-channel audio signal; inserting a multi-channel identification flag into an audio block based on the determination result; and creating an audio bit stream including the ancillary data region in which the multi-channel identification flag is inserted.

The present invention provides the method of transmitting a multi-channel audio signal, in which, if ancillary data is included in the ancillary data region of the subframe, a multi-channel identification flag indicating that the data included in the ancillary data region is ancillary data is inserted into the audio block.

The present invention provides the method of transmitting a multi-channel audio signal in which, if ancillary data is not included in the ancillary data region of the subframe, a channel identifier is inserted into the ancillary data region of the subframe, and, at the same time, the multi-channel identification flag indicating that the data included in the ancillary data region is the channel identifier is inserted into the audio block.

The present invention provides the method of transmitting a multi-channel audio signal, in which the multi-channel identification flag is inserted into any other data region of the subframe.

In accordance with a further aspect, the present invention provides an apparatus for transmitting a multi-channel audio signal, which includes: a reception unit receiving the audio signal; a multi-channel determination unit determining whether the received audio signal is a multi-channel audio signal; a format change unit changing a format of a subframe if it is determined that the received audio signal is a multi-channel audio signal; a channel identifier insertion unit inserting a channel identifier into an ancillary data region of the subframe, the format of which is changed; and a framing unit creating an audio bit stream including the ancillary data region into which the channel identifier is inserted.

The present invention provides the apparatus for transmitting a multi-channel audio signal, in which the format change unit removes the audio data region of the subframe and inserts an ancillary data region into the removed audio data region.

The present invention provides the apparatus for transmitting a multi-channel audio signal, in which a size of the inserted ancillary data region is variably determined according to the number of channels of the multi-channel audio signal, and the removed audio data region has the same size as that of the inserted ancillary data region.

The present invention provides the apparatus for transmitting a multi-channel audio signal, in which the removed audio data region is placed at a least significant bit.

According to the present invention, multiple channels can be supported without changing existing standards in an environment which does not support the multiple channels by inserting a channel identifier in an ancillary data region.

Furthermore, when the multiple channels are supported by inserting the channel identifier into the ancillary data region even in an existing environment which supports the multiple channels, a time for data buffering can be reduced, and a multi-channel audio signal can be efficiently transmitted with a small data storage area.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a schematic diagram of an audio signal transmission apparatus according to one embodiment of the present invention;

FIG. 2 is a view of a format of a subframe according to one embodiment of the present invention;

FIG. 3 is a flowchart illustrating a method of supporting multiple channels using an ancillary data region of a subframe according to one embodiment of the present invention;

FIG. 4 is a flowchart illustrating a method of adaptively supporting multiple channels using a multi-channel identification flag according to one embodiment of the present invention;

FIG. 5 is a schematic diagram of a channel state data according to one embodiment of the present invention;

FIG. 6 is a flowchart illustrating a method of supporting multiple channels using an ancillary data region when a channel state data supports multiple channels, according to one embodiment of the present invention;

FIG. 7 is a flowchart illustrating a method of supporting multiple channels using a format change according to one embodiment of the present invention; and

FIG. 8 is a flowchart illustrating a method of supporting multiple channels using a format change when a channel state data supports multiple channels, according to one embodiment of the present invention.

### DETAILED DESCRIPTION

Terms used in the following description and claims should be interpreted as having a meaning that is consistent with their meaning in the context of the specification and relevant art, and should not be interpreted in an idealized or overly formal sense as defined in commonly used dictionaries, since the inventors can properly define the concept of the terms in order to describe their invention in the best way. In addition, embodiments disclosed in the specification and the features shown in the drawings are merely preferred embodiments of the present invention and do not cover the entire technical idea of the present invention. Thus, it should be understood that such embodiments may be replaced by various equivalents and modifications at the time point when the present application is filed.

The present invention relates to a method and apparatus for transmitting a multi-channel audio signal, and, more particularly, a method and apparatus for supporting multiple channels according to a format of a subframe. Hereinafter, exemplary embodiments of the present invention will be described in detail with reference to the accompanying drawings.

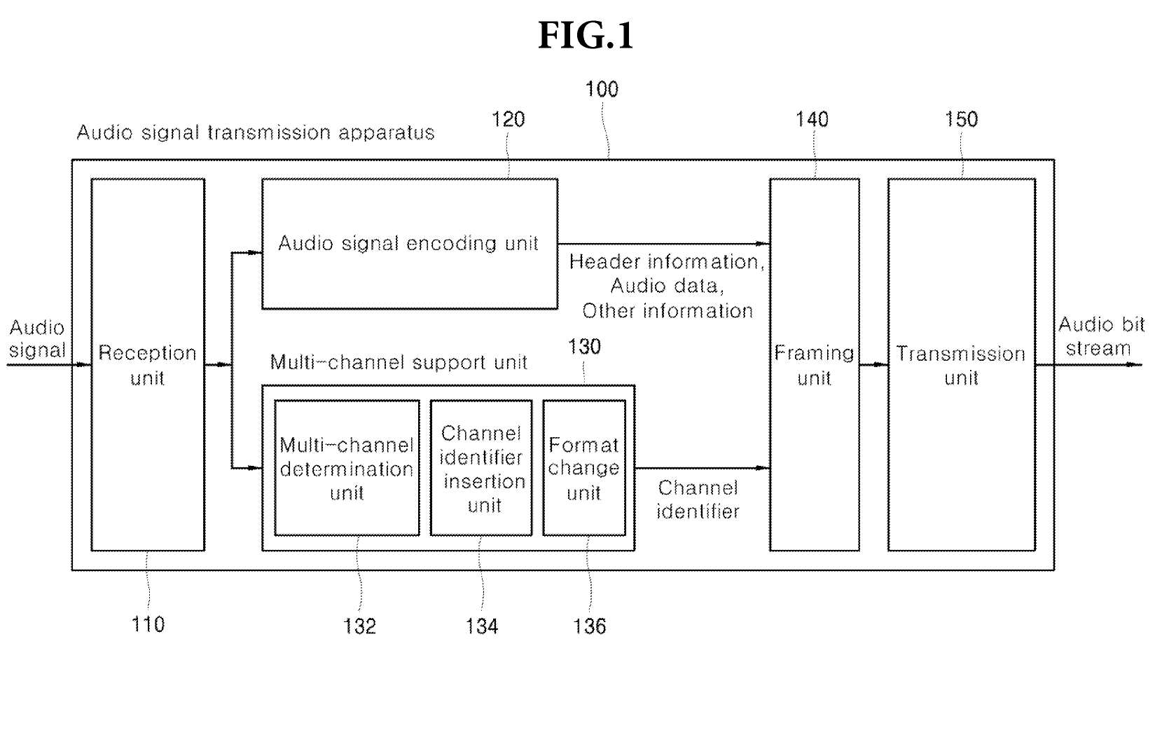

FIG. 1 is a schematic diagram of an audio signal transmission apparatus according to one embodiment of the present invention.

Referring to FIG. 1, an audio signal transmission apparatus 100 according to one embodiment of the present invention may include a reception unit 110, an audio signal encoding unit 120, a framing unit 140, and a transmission unit 150. The reception unit 110 may receive an audio signal. The audio signal may be a multi-channel audio signal. The audio signal encoding unit 120 may encode the received audio signal using an audio codec (e.g., AC3, AAC, SAOC, USAC, and the like). The framing unit 140 may create an audio bit stream by arranging the encoded audio signal in a format of a frame or a subframe. The transmission unit 150 may transmit the created audio bit stream to a decoder (not shown).

The audio signal transmission apparatus 100 may further include a multi-channel support unit 130 to support a multi-channel audio signal. The multi-channel support unit 130 may include a multi-channel determination unit 132 and a channel identifier insertion unit 134. The multi-channel determination unit 132 may determine whether the received audio signal is a multi-channel audio signal. If the received audio signal is a multi-channel audio signal, the channel identifier insertion unit 134 may insert a channel identifier in units of subframes. The channel identifier may mean a number for distinguishing each channel of the audio signal. In addition, the multi-channel support unit 130 may further include a format change unit 136 when a format of the subframe needs to be changed to support multiple channels. The format change unit 136 may change the format into a format of a subframe having ancillary data by substituting a part of the audio data with the ancillary data. Hereinafter, the subframe format will be described.

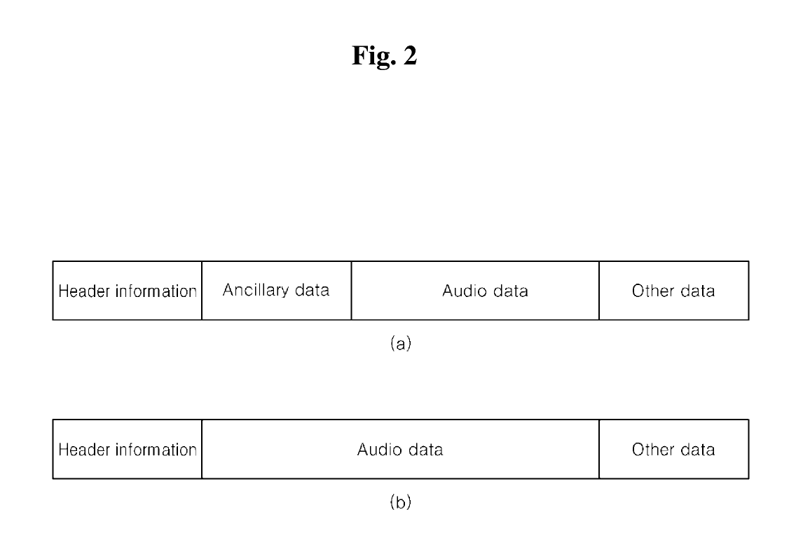

FIG. 2 is a view of a subframe format according to one embodiment of the present invention.

A subframe may mean a minimum data unit transmitting audio data.

Referring to FIG. 2, the subframe may have a header region, an audio data region, and other data regions. Header information of audio data (e.g., sampling rate, bit rate, number and position of scale factors, data size, time table and the like) can be included in the header region. Encoded audio data can be included in the audio data region. In addition, if the length of audio data is short, the subframe may further include an ancillary data region, as shown in FIG. 2(a). On the contrary, if the length of audio data is long, the subframe may not include the ancillary data region as shown in FIG. 2(b).

As used herein, a frame is made up of two subframes, and an audio block may mean an aggregate of frames. Hereinafter, a method of supporting multiple channels according to subframe format will be described in detail.

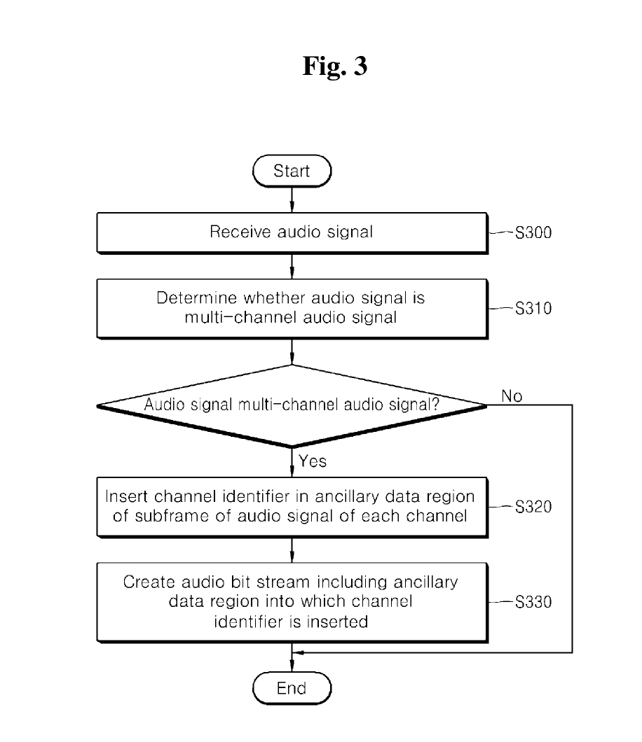

FIG. 3 is a flowchart illustrating a method of supporting multiple channels using an ancillary data region of a subframe according to one embodiment of the present invention.

This embodiment may be applied in an environment which does not support multiple channels (e.g., IEC 60958-3 or the like). For example, although IEC 60958-3, which is a part of the IEC 60958 specification, contains definitions of a consumer application of an interface for connecting a digital audio device, it does not support multiple channels. However, by application of this embodiment, IEC 60958-3 may support multiple channels without changing the existing IEC 60958.

Referring to FIG. 3, the reception unit 110 may receive an audio signal (S300). The multi-channel determination unit 132 may determine whether the received audio signal is a multi-channel audio signal (S310). If it is determined that the received audio signal is a multi-channel audio signal, the channel identifier insertion unit 134 may insert a channel identifier into the ancillary data region of a subframe of the audio signal of each channel (S320). The framing unit 140 may create an audio bit stream including the ancillary data region into which the channel identifier is inserted (S330). That is, the audio bit stream is created in units of subframes and can be created by arranging the header information, the channel identifier included in the ancillary data region, the audio data and other data based on subframe format.

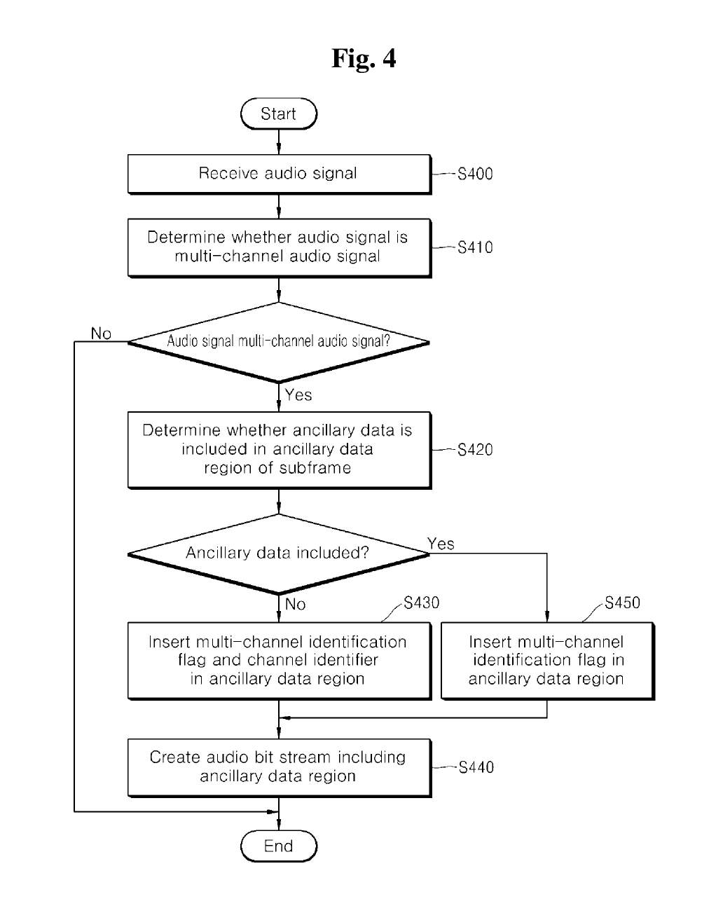

However, a method of supporting multiple channels using the ancillary data region can be restrictively used based on a multi-channel identification flag and will be described with reference to FIG. 4.

FIG. 4 is a flowchart illustrating a method of adaptively supporting multiple channels using a multi-channel identification flag according to one embodiment of the present invention.

First, the multi-channel identification flag may mean information indicating whether the data included in the ancillary data region is a channel identifier or ancillary data. The multi-channel identification flag may be expressed in one bit. For example, if the multi-channel identification flag is ‘1’, it means that data in the ancillary data region is a channel identifier, and if the multi-channel identification flag is ‘0’, it means that data in the ancillary data region is ancillary data. If the multi-channel identification flag is used, the decoder may determine whether information inserted into the ancillary data region is a channel identifier or ancillary data by parsing information on the multi-channel identification flag.

Referring to FIG. 4, the reception unit 110 may receive an audio signal (S400). The multi-channel determination unit 132 may determine whether the received audio signal is a multi-channel audio signal (S410). If the received audio signal is a multi-channel audio signal as a result of the determination in S410, the channel identifier insertion unit 134 may determine whether ancillary data is included in the ancillary data region of a subframe (S420). If ancillary data is not included in the ancillary data region as a result of the confirmation in S420, a multi-channel identification flag, which indicates that the data included in the ancillary data region is a channel identifier, and a channel identifier may be inserted into the ancillary data region (S430). Accordingly, multiple channels can be adaptively supported according to presence of ancillary data using the multi-channel identification flag. Here, the multi-channel identification flag is not limited to insertion into the ancillary data region and may be inserted into any other data region of the subframe or into the header region of a group of subframes (e.g., an audio block or the like) having the same channel identifier. The framing unit 140 may create an audio bit stream including the ancillary data region in which the multi-channel identification flag and the channel identifier are inserted.

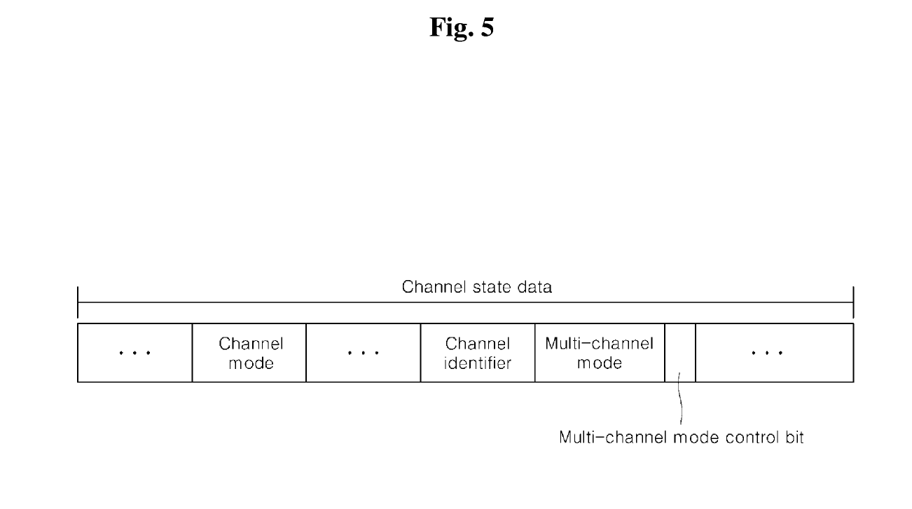

Conversely, if ancillary data is included in the ancillary data region as a result of the confirmation at S420, a multi-channel identification flag indicating that the data included in the ancillary data region is ancillary data may be inserted into the ancillary data region (S450). Of course, if ancillary data is included in the ancillary data region, the multi-channel identification flag may not be inserted. That is, if the multi-channel identification flag does not exist, the decoder may know that the data included in the ancillary data region is ancillary data. Hereinafter, a method of supporting multiple channels using a channel state data will be described with reference to FIG. 5.

FIG. 5 is a schematic diagram of a channel state data according to one embodiment of the present invention.

Channel state data means information on a channel of audio data. Referring to FIG. 5, the channel state data may include a channel mode, a multi-channel mode control bit, a multi-channel mode, and a channel identifier.

The channel mode will be described with reference to Table 1. Table 1 shows channel modes corresponding to bit values. Referring to Table 1, the channel mode means an audio channel encoding mode at the transmission side and includes an unassigned mode, a two-channel mode, a single-channel mode, a multi-channel mode, and the like. The channel mode may be set to the multi-channel mode by inserting a bit value corresponding to the multi-channel mode in the channel state data.

TABLE 1

| Bit Value | Channel Mode |
|---|---|
| 0000 | Unassigned Mode |
| 0001 | Two-channel Mode |
| 0010 | Single-channel Mode |
| . | . |
| . | . |
| . | . |
| 1111 | Multi-channel Mode |

Herein, the multi-channel mode control bit is information on whether the multi-channel mode is a defined multi-channel mode or an undefined multi-channel mode. If the multi-channel mode is a defined multi-channel mode according the multi-channel mode control bit, information on the number and the channel identifier of the defined multi-channel mode can be inserted into the channel state information. Information on the number of the defined multi-channel mode means an audio multi-channel encoding mode at the transmission side as shown in Table 2.

TABLE 2

| Bit Value | Multi-channel Mode |
|---|---|
| 000 | Multi-channel Mode 0 |
| 100 | Multi-channel Mode 1 |
| 010 | Multi-channel Mode 2 |
| 110 | Multi-channel Mode 3 |
| 111 | User-defined Multi-channel Mode |

Contrarily, if the multi-channel mode is an undefined multi-channel mode according the multi-channel mode control bit, only a channel identifier can be inserted into the channel state data. As described above, the channel state data may support multi-channel by providing information on whether multiple channels are used and a channel identifier for distinguishing each audio channel.

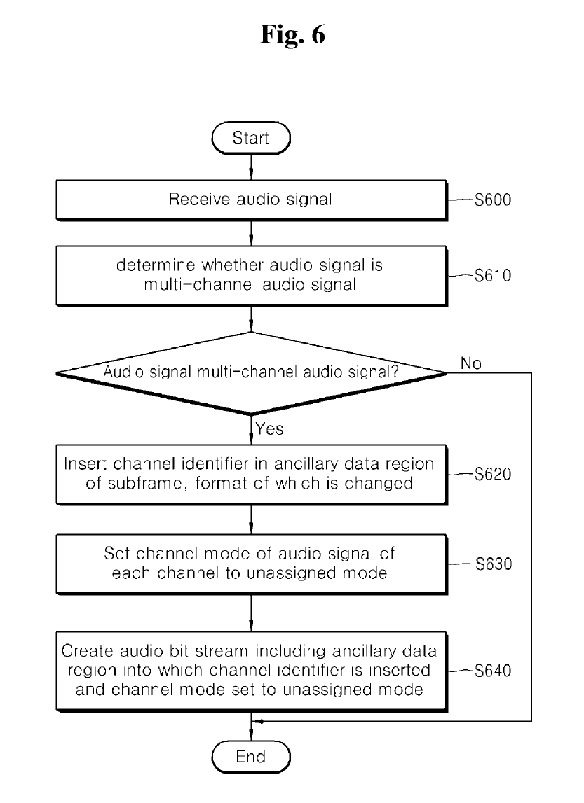

However, the channel state data is distributed in the subframes of one audio block. Accordingly, an encoder should transmit audio data of the same channel in unit of a data size of one audio block, and this means that the encoder should store at least one audio block per channel. This means that the decoder also store at least one audio block per channel in order to play back the audio data. That is, when multi-channel audio is supported using the channel state data, there is a limit in that a great deal of time is consumed for data buffering and a large data storage area is required. However, the ancillary data region of a subframe may be used to overcome the limit, and this will be described below with reference to FIG. 6.

FIG. 6 is a flowchart illustrating a method of supporting multiple channels using an ancillary data region when channel state data supports the multiple channels, according to one embodiment of the present invention.

This embodiment may be applied in an environment which supports multiple channels. For example, IEC 60958-4, which is a part of the IEC 60958 specification, contains definitions of a professional application of an interface for connecting a digital audio device and may support multiple channels by using channel state data including a channel mode and a channel identifier as described above. However, according to the present embodiment, the limit of the data buffering time and the data storage area can be improved without changing the existing IEC 60958.

Referring to FIG. 6, the reception unit 110 may receive an audio signal (S600). The multi-channel determination unit 132 may determine whether the received audio signal is a multi-channel audio signal (S610). If it is determined that the received audio signal is a multi-channel audio signal, the channel identifier insertion unit 134 may insert a channel identifier into the ancillary data region of a subframe of the audio signal of each channel (S620). At the same time, the multi-channel support unit 130 may set the channel mode of the audio signal of each channel to an unassigned mode (S630). The framing unit 140 may create an audio bit stream including the ancillary data region, into which the channel identifier is inserted, and the channel mode set to the unassigned mode (S640).

In addition, it should be understood that the multi-channel identification flag described in FIG. 4 may be used in this embodiment, and details thereof will be omitted.

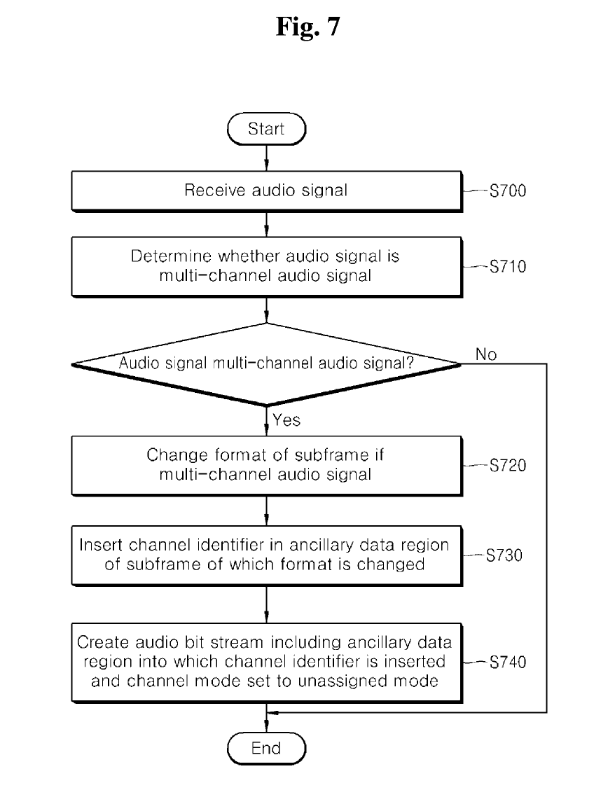

FIG. 7 is a flowchart illustrating a method of supporting multiple channels using a format change according to one embodiment of the present invention.

This embodiment may be applied in an environment which does not support multi-channel audio (e.g., IEC 60958-3 or the like) and may be applied when the format of a subframe comprises header information, audio data and other data. That is, this may be applied when the format of a subframe does not include an ancillary data region. Therefore, IEC 60958-3 may support multiple channels without changing the existing IEC 60958.

Referring to FIG. 7, the reception unit 110 may receive an audio signal (S700). The multi-channel determination unit 132 may determine whether the received audio signal is a multi-channel audio signal (S710).

If it is determined that the received audio signal is a multi-channel audio signal, the format change unit 136 may perform a format change on the subframe (S720). The format change may mean changing a format which does not include an ancillary data region into a format including an ancillary data region. This may mean that an audio data region is removed and an ancillary data region is inserted. The removed audio data region may have the same size as that of the inserted ancillary data region. The size of the inserted ancillary data region may be a size of a general ancillary data region (e.g., 4 bits) or can be variably determined depending on the number of channels. The removed audio data region may be placed at the least significant bit. However, the position of the removed audio data region is not limited to the least significant bit, but can be selectively determined within a range from the most significant bit to the least significant bit.

The channel identifier insertion unit 134 may insert a channel identifier into the ancillary data region of a subframe, the format of which is changed (S730). The framing unit 140 may create an audio bit stream including the ancillary data region into which the channel identifier is inserted (S740). In addition, it should be understood that the multi-channel identification flag described in FIG. 4 may be used in this embodiment, and details thereof will be omitted.

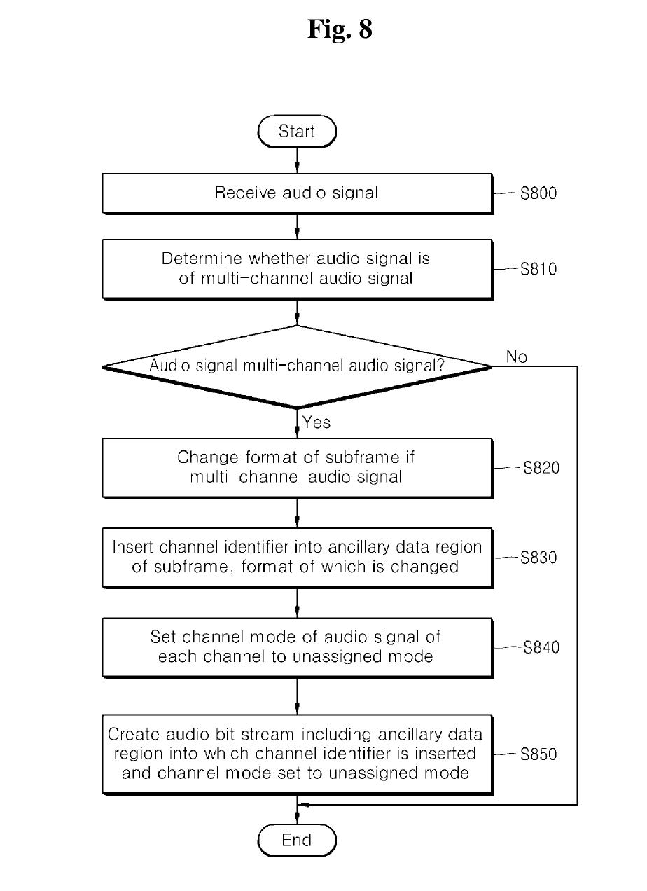

FIG. 8 is a flowchart illustrating a method of supporting multiple channels using a format change when a channel state data supports the multi-channel, according to one embodiment of the present invention.

This embodiment may be applied in an environment which supports multi-channel audio (e.g., IEC 60958-4 or the like) and may be applied when a format of a subframe does not include an ancillary data region. According to the embodiment, the limit of data buffering time and data storage area can be improved without changing the existing IEC 60958.

Referring to FIG. 8, the reception unit 110 may receive an audio signal (S800). The multi-channel determination unit 132 may determine whether the audio signal is a multi-channel audio signal (S810). If it is determined that the audio signal is a multi-channel audio signal, the format changing unit 136 may perform a format change on the subframe. Since the meaning and method of the format change are described in FIG. 7, details thereof will be omitted. The channel identifier insertion unit 134 may insert a channel identifier into the ancillary data region of a subframe, the format of which is changed (S830). At the same time, the multi-channel support unit 130 may set the channel mode of the audio signal of each channel to an unassigned mode (S840). The framing unit 140 may create an audio bit stream including the ancillary data region, into which the channel identifier is inserted, and the channel mode set to the unassigned mode (S850). In addition, it should be understood that the multi-channel identification flag described in FIG. 4 may be used in this embodiment, and details thereof will be omitted.

It is apparent that the method of encoding a multi-channel audio signal described above can be created as a computer program. Code and code segments of the program may be easily deduced by a computer programmer in the art. In addition, the program is stored in computer readable media and is read and executed by a computer to implement the driving information storage method. The storage media may include magnetic recording media, optical recording media, and carrier wave media.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A method of transmitting a multi-channel audio signal, comprising:
receiving an audio signal;
determining whether the received audio signal is a multi-channel audio signal;
changing a format of a subframe if it is determined that the received audio signal is a multi-channel audio signal;
inserting a channel identifier into an ancillary data region of the subframe, the format of which is changed; and
creating an audio bit stream including the ancillary data region into which the channel identifier is inserted,
wherein the format of the subframe comprises header information, audio data and other data, and the format change means changing a format of a subframe which does not include an ancillary data region into a format of a subframe including an ancillary data region.

2. The method according to claim 1, wherein the changing a format comprises:
removing the audio data region of the subframe; and
inserting an ancillary data region into the removed audio data region.

3. The method according to claim 2, wherein a size of the inserted ancillary data region is variably determined according to the number of channels of the multi-channel audio signal, and the removed audio data region has the same size as that of the inserted ancillary data region.

4. The method according to claim 2, wherein the removed audio data region is placed at a least significant bit.

5. A method of transmitting a multi-channel audio signal, comprising:
receiving an audio signal;
determining whether the received audio signal is a multi-channel audio signal;
determining whether ancillary data is included in an ancillary data region of a subframe if it is determined that the received audio signal is a multi-channel audio signal;
inserting a multi-channel identification flag into an audio block based on the determination result; and
creating an audio bit stream including the ancillary data region into which the multi-channel identification flag is inserted,
wherein the multi-channel identification flag is information on whether the data included in the ancillary data region is a channel identifier or ancillary data.

6. The method according to claim 5, wherein, if ancillary data is included in the ancillary data region of the subframe, a multi-channel identification flag indicating that the data included in the ancillary data region is ancillary data is inserted into the audio block.

7. The method according to claim 5, further comprising:
inserting a channel identifier into the ancillary data region of the subframe if ancillary data is not included in the ancillary data region of the subframe,
wherein a multi-channel identification flag indicating that the data included in the ancillary data region is the channel identifier is inserted into the audio block.

8. The method according to claim 5, wherein the multi-channel identification flag is inserted into any other data region of the subframe.

9. An apparatus for transmitting a multi-channel audio signal, comprising:
a reception unit receiving an audio signal;
a multi-channel determination unit determining whether the received audio signal is a multi-channel audio signal;
a format change unit changing a format of a subframe if it is determined that the received audio signal is a multi-channel audio signal;
a channel identifier insertion unit inserting a channel identifier into an ancillary data region of the subframe, the format of which is changed; and
a framing unit creating an audio bit stream including the ancillary data region into which the channel identifier is inserted,
wherein the format of the subframe comprises header information, audio data and other data, and the format change means changing a format of a subframe which does not include an ancillary data region into a format of a subframe including an ancillary data region.

10. The apparatus according to claim 9, wherein the format change unit removes the audio data region of the subframe and inserts an ancillary data region into the removed audio data region.

11. The apparatus according to claim 10, wherein a size of the inserted ancillary data region is variably determined according to the number of channels of the multi-channel audio signal, and the removed audio data region has the same size as that of the inserted ancillary data region.

12. The apparatus according to claim 10, wherein the removed audio data region is placed at a least significant bit.
